(19) United States
(12) Patent Application Publication
(10) Pub. No.: US 2008/0124978 A1
(43) Pub. Date: May 29, 2008

(54) Electrical connector

(75) Inventor: Ted Ju, Keelung (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: LOTES Co., Ltd.

(21) Appl. No.: 11/605,426

(22) Filed: Nov. 29, 2006

(51) Int. Cl. H01R 24/00

(52) U.S. Cl. 439/626

(57) ABSTRACT

The present invention discloses an electrical connector, comprising an insulating body and a plurality of electrical terminals. The insulating body is disposed with a plurality of terminal receiving chambers. The electrical terminals are accommodated in the terminal receiving chambers and disposed with a resilient body, respectively, to provide the electrical terminals with resilience. The electrical connector is disposed with resilient bodies to operate in coordination with the electrical terminals; the resilient bodies provide the electrical terminals with resilience in general, so as to achieve a better electrical contact with electronic devices involved. Furthermore, the electrical connector according to present invention having better electrical conductivity and higher resilience at a lower price, and is able to overcome the drawbacks in conventional art and maintain a better performance through the service life.

### FIELD OF THE INVENTION

The present invention relates to an electrical connector and in particular to an electrical connector which is disposed with a resilient body to operate in coordination with electrical terminals.

### BACKGROUND OF THE INVENTION

Electrical connectors are the bridge of electrical connection between various electronic devices and, to a large extent, determine the performance and service life of the electronic devices involved. Consequently, electrical connectors are very important for electronic products. The structure and material of the electrical connector is therefore a focused point in the research and development of the electrical connector industry. At the present time, the electrical terminal of an electrical connector is usually made of a simplex metal, whose electrical conductivity and resilience are usually defective. In order to obtaining both high electrical conductivity and high resilience for an electrical terminal, the best natural material such as gold or silver has to be applied, but for commercial electrical connectors, those materials are much too expensive to suitable for mass production, whereas other conventional materials are always very hard to compromise between electrical conductivity and resilience.

Consequently, it is necessary to design a novel electrical connector to overcome the drawbacks described above.

### SUMMARY OF THE INVENTION

The primary objective of the present invention is to provide an electrical connector with high electrical conductivity and high resilience at a lower price.

Another object of the present invention is to provide an electrical connector, comprising an insulating body and a plurality of electrical terminals, the insulating body disposed with a plurality of terminal receiving chambers, the electrical terminals accommodated in the terminal receiving chambers and disposed with a resilient body, respectively, to provide the electrical terminals with resilience.

Yet another object of the present invention is to provide an electrical connector, comprising an insulating body and a plurality of electrical terminals, the insulating body disposed with a plurality of terminal receiving chambers, the electrical terminals accommodated in the terminal receiving chambers, the electrical terminals comprising a contact portion for contacting with the mating electronic device, and one side of the contact portion disposed with a resilient portion to provide the electrical terminal with resilience.

Compared with the conventional art, an electrical connector according to the present invention is disposed with resilient bodies to coordinate with the electrical terminals; the resilient bodies provide the electrical terminals with resilience, so as to achieve a better electrical contact with the electronic devices involved. Furthermore, the electrical connector according to the present invention having better electrical conductivity and higher resilience at a lower price, and it is able to overcome the drawbacks in conventional art and maintain a better performance throughout the service life.

### BRIEF DESCRIPTION OF THE DRAWINGS

The present invention can be more fully understood by reference to the following description and accompanying drawings, in which:

FIG. 1 schematically illustrates an exploded perspective view of an electrical connector according to the present invention;

FIG. 2 schematically illustrates a perspective assembly view of an electrical connector according to the present invention;

FIG. 3 schematically illustrates a perspective view of the insulating body of an electrical connector shown in FIG. 1;

FIG. 4 schematically illustrates a perspective view of the attachment of the electrical terminal and spring of an electrical connector according to the present invention; and

FIG. 5 schematically illustrates an exploded perspective view of an electrical connector according to the second embodiment of the present invention.

### DETAILED DESCRIPTION OF THE INVENTION

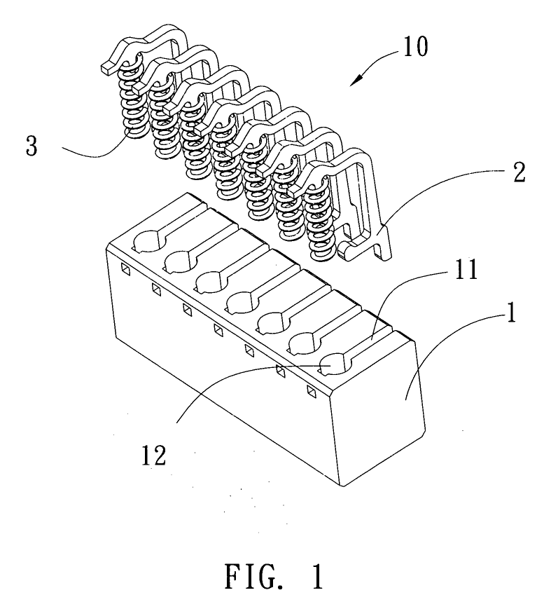

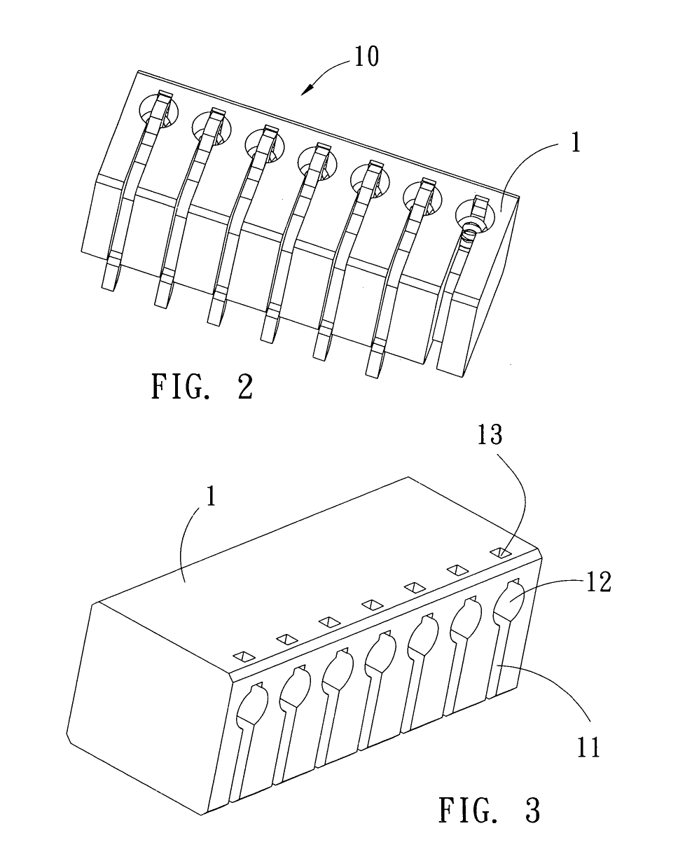

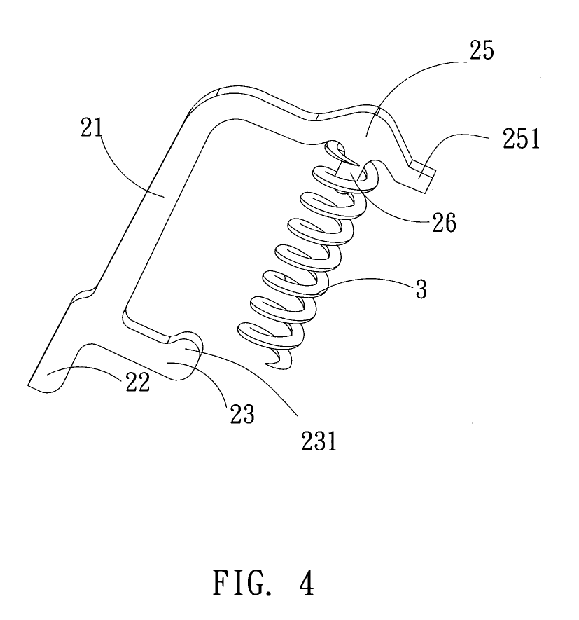

With reference to FIGS. 1 to 4, an electrical connector 10 according to the present invention comprises an insulating body 1, a plurality of electrical terminals 2, and resilient bodies 3 extending from one ends of the electrical terminals to provide resilience, a preferred embodiment is spring for example, attached to the electrical terminals 2 to provide them with resilience.

The insulating body 1 is disposed with a plurality of terminal receiving chambers 11 are arranged in parallel for receiving the electrical terminals 2. The terminal receiving chamber 11 are arranged in parallel and their one end is disposed with an accommodating hole, the accommodating hole is a blind hole 12 in the present embodiment, and one sidewall of the blind hole 12 is running through the terminal receiving chamber 11. The diameter and depth of the blind hole 12 are slightly larger than those of the spring 3, the blind hole 12 in a vertical direction perpendicular to the corresponding terminal receiving chamber 11. Also, a through hole 13 is disposed on one side of the insulating body 1 running through another sidewall of the blind hole 12 opposite to the terminal receiving chamber 11 to restrict the horizontal movement of the electrical terminal 2 by operating in coordination with the electrical terminal 2.

The electrical terminals 2 are made of red brass, which possesses good electrical conductivity with relatively low resilience, comprising an inserting portion 26 on its one end and a fastening portion 23 on the other end. The spring 3 is inserted into the inserting portion 26 with one end of the spring 3 and accommodated in the blind hole 12 with the other end of the spring 3 against the bottom surface of the blind hole 12. In such a structure, when the electrical terminal 2 is under pressure, the spring 3 may provide the electrical terminal 2 with resilience. The electrical terminal 2 further comprises a main body 21, a contact portion 25 bent and extending upwardly from the main body 21 for electrically contacting with a mating electronic device (not shown), and a welding portion 22 extending downwardly from the fastening portion 23 for being soldered onto a circuit board (not shown) so as to establish electrical connection between the mating electronic device and the circuit board. The inserting portion 26 is formed by extending downwardly from the contact portion 25, and the fastening portion 23 is formed by extending horizontally from the joint of the welding portion 22 and the main body 21, wherein the front end of the fastening portion 23 is disposed with a protruding portion 231 to coordinate with the terminal receiving chamber 11 to restrict the longitudinal movement of the electrical terminal 2. Furthermore, the limit portion 251 of the contact portion 25 may be inserted into the through hole 13 to restrict the horizontal movement of the electrical terminal 2.

When the electrical connector 10 connecting with the mating electronic device, the electrical terminal 2 moves downwardly and the spring 3 will render a resilient force against the electrical terminals 2, such that the contact portion 25 of the electrical terminal 2 will form a better contact with the electronic device, establish a better electrical connection in between. Consequently, the electrical terminal 2 may overcome the drawback of insufficient resilience and thus to achieve a better electrical connection.

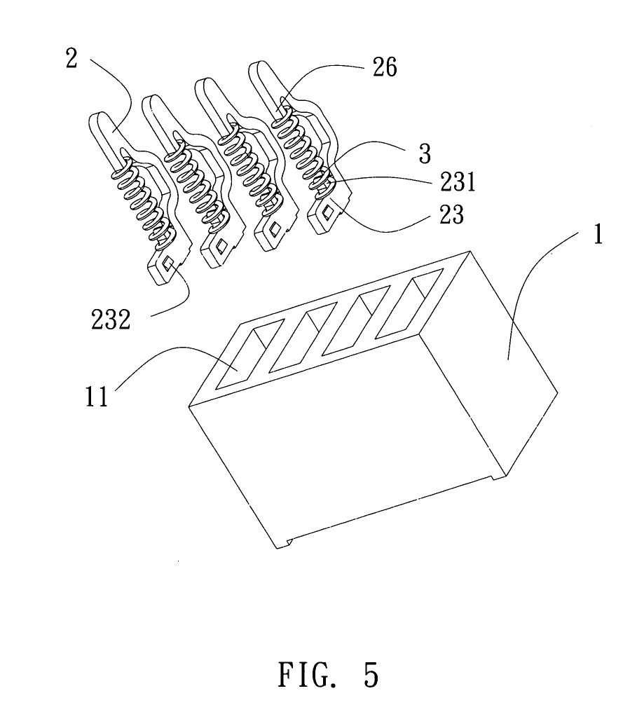

With reference to FIG. 5, the second embodiment of the electrical connector according to the present invention is disclosed. Compare with the first embodiment, a protruding portion 231 is disposed on the fastening portion 23 in the present embodiment; the spring 3 is attached between the inserting portion 26 and the protruding portion 231 of the fastening portion 23. Also, a small hook 232 is disposed on the fastening portion 23 for coordinating with the terminal receiving chamber 11, in order to tightly fasten the electrical terminal 2 in the terminal receiving chamber 11 of the insulating body 1. Similarly, the present embodiment can also achieve the goals described in the previous embodiment.

While the invention has been described with reference to the a preferred embodiment thereof, it is to be understood that modifications or variations may be easily made without departing from the spirit of this invention, which is defined by the appended claims.

What is claimed is:

1. (canceled)

2. The device as defined in claim 13, wherein the electrical terminal comprises a main body and a contact portion extending upwardly from the main body, and the resilient body is disposed on one side of the main body.

3. The device as defined in claim 2, wherein the electrical terminal further comprises a fastening portion disposed on the other side of the main body, and one side of the resilient body is abutted against the fastening portion.

4. The device as defined in claim 13, wherein the insulating body is disposed with accommodating holes to receive resilient bodies, and one side of the resilient body is abutted against the accommodating hole.

5. The device as defined in claim 4, wherein the accommodating hole is a blind hole.

6. The device as defined in claim 2, wherein the front end of the contact portion is disposed with a limit portion and correspondingly, one on side of the terminal receiving chamber is disposed with a through hole in coordination with the limit portion.

7. The device as defined in claim 3, wherein the electrical terminal further comprises an inserting portion extending downwardly from the contact portion, a protruding portion extending upwardly from the fastening portion, and a welding portion extending downwardly from the fastening portion.

8. The device as defined in claim 7, wherein the contact portion protrudes out of the terminal receiving chamber and the welding portion protrudes out of the terminal receiving chamber.

9. The device as defined in claim 13, wherein the electrical terminal is made of materials with good electrical conductivity.

10. The device as defined in claim 13, wherein the electrical terminal is made of copper.

11. The device as defined as claim 13, wherein the resilient body is a spring.

12. (canceled)

13. An electrical connector comprising:
a) an insulating body having:
i) a plurality of accommodating holes; and
ii) a plurality of terminal receiving chambers; and
b) a plurality of electrical terminals accommodated in the terminal receiving chambers, each electrical terminal having:
i) a main body;
ii) a contact portion extending from the main body;
iii) an inserting portion extending downward from the contact portion; and
iv) a resilient body located in a corresponding accommodating hole of the plurality of accommodating holes and having a first end located on the inserting portion to provide the electrical terminals with resilience and a second end abutting against the corresponding accommodating hole.

14. An electrical connector comprising:
a) an insulating body having:
i) a plurality of accommodating holes; and
ii) a plurality of terminal receiving chambers; and
b) a plurality of electrical terminals accommodated in the terminal receiving chambers, each electrical terminal comprising:
i) a main body;
ii) a contact portion extending from a first end of the main body for contacting with the mating electronic device;
iii) an inserting portion extending downward from the contact portion;
iv) a fastening portion located on a second end of the main body and having a protruding portion extending upwardly from the fastening portion; and
v) a resilient body located in a corresponding accommodating hole of the plurality of accommodating holes and having a first end located on one side of the contact portion to provide the electrical terminal with resilience and a second end abutting against the corresponding accommodating hole.
